(19) United States
(12) Patent Application Publication
(10) Pub. No.: US 2009/0136798 A1
(43) Pub. Date: May 28, 2009

(54) Autothermic Reformer

(75) Inventors: Ralf Peters, Wuerselen (DE); Andreas Tschauder, Westerkappeln (DE); Joachim Pasel, Juelich (DE); Detlef Stolten, Aachen (DE)

Correspondence Address: JORDAN AND HAMBURG LLP, 122 EAST 42ND STREET, SUITE 4000, NEW YORK, NY, 10168, US

(73) Assignee: Forschungszentrum Juelich GmbH, Juelich (DE)

(21) Appl. No.: 11/921,495

(22) PCT Filed: May 31, 2006
(86) PCT No.: PCT/DE2006/000946

§ 371 Date: Dec. 3, 2007

(30) Foreign Application Priority Data
Jun. 10, 2005 (DE) 10 2005 026 780.7

(51) Int. Cl. H01M 8/18; H01M 8/04

(52) U.S. Cl. 429/17; 429/20

(57) ABSTRACT

The invention relates to a device for producing a product gas which is rich in hydrogen, comprising a reformer part which comprises an inlet for a fuel/oxidation agent mixture, an inlet for a water/carrier gas mixture, a catalytic surface and a first heat exchanger. Said device also comprises a combustion part which comprises an inlet for an anode residual gas from a fuel cell, an inlet for an oxidation agent, a catalytic surface and a second and a third heat exchanger. The reformer part and the combustion part are connected via lines which are used to guide a water vapour/catrier gas mixture and for directing the reformat. According to the inventive method for producing a product gas which is rich in hydrogen, a first mixing chamber guides a water vapour/carrier gas mixture via a line and a fuel/oxidation agent mixture via a nozzle. The fuelwater vapour/oxidation agent/carrier gas mixture is catalytically converted into a product gas which is rich in hydrogen in exothermic and endothermic reactions. The anode residual gas from the fuel cell is catalytically converted in exothermic reactions into waste gas having few harmful substances. The heat required for evaporating water into water vapour in the water vapour/carrier gas mixture is partially produced by cooling the product gas which is rich in hydrogen and partially by cooling the waste gas of the combustion which contains few harmful substances.

The invention relates to an autothermic reformer for producing a hydrogen-rich gas mixture for use in a fuel cell.

### PRIOR ART

As a rule, pure hydrogen is regularly required for operating polymer electrolyte membrane (PEM) fuel cells. Hydrogen-rich product gas is generally produced from hydrocarbons using reformers. There the so-called reformate is produced catalytically or even non-catalytically from a fuel, as a rule from alcohols (e.g. methanol or ethanol) or hydrocarbons (e.g. methane, natural gas, propane, diesel, kerosene) with water, with an oxidizing agent, or with water and an oxidizing agent. Once it has been purified in a multi-stage gas purification unit, which as a rule comprises a two-stage shift reactor and subsequent preferential oxidizing, this reformate is then supplied to the polymer electrolyte membrane fuel cell. The residual anode gas from the polymer electrolyte membrane fuel cell is converted in a burner using an oxidizing agent.

As a rule, the individual chemical reactions run at different temperatures, for instance the reformation at 250 to 900° C. and the subsequent purification of the reformate at 200-400° C. in the shift reactor and at 50-200° C. in the reactor for preferential oxidation. In addition, some heat is produced in the individual reactions or in some cases additional heat is even needed.

### OBJECT AND SOLUTION

The object of the invention is to provide an autothermic reformer for producing hydrogen for a fuel cell, which reformer can be operated with as little externally supplied heat as possible. In particular the autothermic reformer should provide the vapor required for the reformation process and should use the heat from the exhaust gas of the burner.

### SUBJECT-MATTER OF THE INVENTION

The underlying idea of the invention is to thermically couple the reformation and the post-combustion of the anode exhaust gas so that such a unit can also be operated nearly autonomously during stationary operation.

The inventive reformer/burner system advantageously solves the problem of evaporating the water that is required for the autothermic reformation in that the heat from the burner exhaust gas and from the reformate is used. In addition, using the heat discharge from the reformate, the reformate temperature is simultaneously lowered to the temperature level of the subsequent purification stage, desulfurization, or high temperature shift stage.

For this purpose, the inventive apparatus has a reformer part and a combustion part. Arranged in the reformer part is a first mixing chamber that has a first inlet that is able to feed in fuel and oxidizing agent via a nozzle, and a second inlet that is able to feed in a water vapor/carrier gas mixture via a supply line. When the autothermic reformer is operating, the oxidizing agent mixes with the fuel, water vapor, and carrier gas, and the liquid fuels (e.g. diesel, kerosene) are evaporated. This mixture is then conducted across a catalytically active surface in a reaction chamber so that it is converted to a hydrogen-rich mixture (reformate). The heat that is released during this process is absorbed by a first heat exchanger and furthermore by a second heat exchanger. Thus the reformate cools off so that it can be conducted out of the inventive apparatus. The reformate then advantageously has a temperature that is necessary for any downstream gas purification steps.

At the same time, residual anode gas from a fuel cell, in particular a PEM, is supplied to the inventive apparatus in the combustion part. This residual gas, together with the required quantity of an oxidizing agent, is also supplied to a catalytic surface, where it reacts exothermically. The heat released during this process is absorbed by a third heat exchanger. The cooled exhaust gas is then removed from the apparatus. As a rule it is low in harmful substances due to the catalytic conversion.

The water/carrier gas mixture that is required for the chemical transformation in the reformer part is added to the apparatus via a feed line and conducted via a first and a second heat exchanger. Heating is performed such that the water is completely evaporated and the mixture is superheated. The water vapor/carrier gas mixture is then supplied in the reformer part via a feed line to the vaporized fuel/oxidizing agent mixture.

The inventive method thermically couples the chemical conversion of the reformer to that of the post-combustion in such a manner that in the optimum case all of the water vapor required for the reformation can be produced without the addition of further external heat. Furthermore, the method reduces the reformate temperature to that required for the subsequent gas purification, and also advantageously cools the residual anode gas of the fuel cell that is converted to exhaust gas in the burner.

The method can be implemented in a suitable manner using the inventive apparatus. It has a reformer part with an inlet for a fuel/oxidizing agent mixture, an inlet for a water/carrier gas mixture, a catalytic surface, and a first heat exchanger having a first passage for the reformate and a second passage for a water/carrier gas mixture.

The apparatus furthermore has a combustion part with an inlet for the residual anode gas from a fuel cell, an inlet for an oxidizing agent, a catalytic surface, and a third heat exchanger, a first passage for the converted residual anode gas, and a second passage for a water/carrier gas mixture.

The combustion part and the reformer part are structurally coupled to one another via at least one supply line for a water vapor/carrier gas mixture.

### SPECIAL DESCRIPTION

In the following the subject-matter of the invention is explained in greater detail using two figures, without this limiting the subject-matter of the invention.

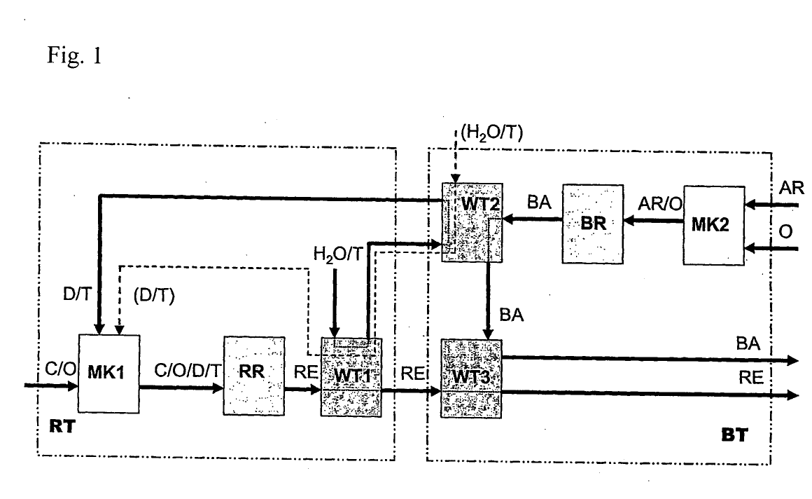

FIG. 1: schematically illustrates the coupling of the heat flows between reformer part RT and combustion part BT;

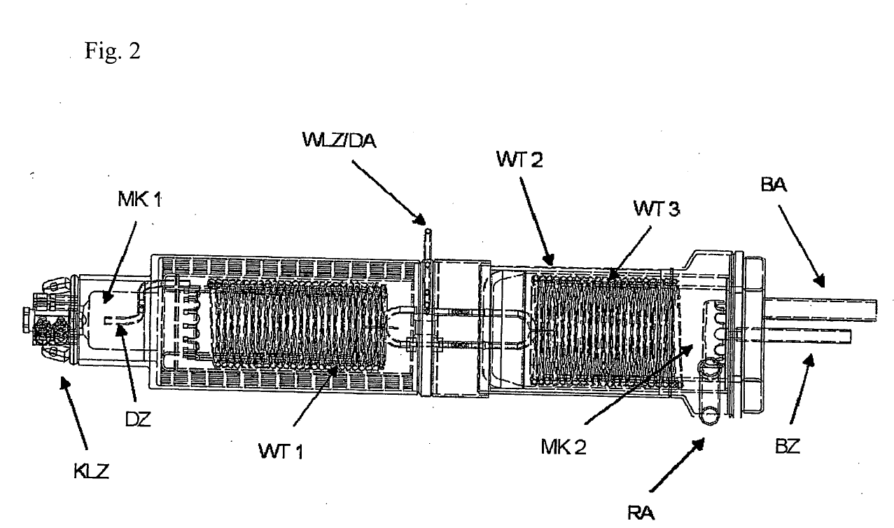

FIG. 2: is a sectional view of an exemplary embodiment.

In the figures:

| | |
|---|---|
| RT | Reformer part |
| BT | Combustion part |
| RR | Reaction chamber |
| BR | Burner chamber |
| MK1 | First mixing chamber |
| MK2 | Second mixing chamber |
| WT1 | First heat exchanger |
| WT2 | Second heat exchanger |
| WT3 | Third heat exchanger |
| C/O | Fuel/oxidizing agent mixture |
| H₂O/T | Water/carrier gas mixture |
| D/T | Water vapor/carrier gas mixture |
| RE | Reformate |
| AR | Residual anode gas |
| BA | Burner exhaust gas |
| AR/O | Residual anode gas/oxidizing agent mixture |
| BZ | Burner supply |
| RA | Reformate outlet |
| WLZ/DA | Water and air supply/vapor outlet |
| DZ | Vapor supply |
| KLZ | Fuel and air supply |

The reaction chamber RR of the autothermic reformer and the burner chamber BR of the burner can be seen in FIG. 1. Exothermal processes occur in both chambers. The heat produced here is at least partially given up on the one hand from the reformate RE by means of the first heat exchanger WT1 and on the other hand from the burner exhaust gas BA by means of the second heat exchanger WT2. Both heat exchangers use this heat for heating a water/oxidizing agent mixture H₂O/T, which is then supplied to the first mixing chamber as water vapor/carrier gas mixture D/T.

FIG. 2 illustrates a section through a heat-coupled reformer part and combustion part of a reformer/burner system. Located on the left-hand side is the mixing chamber, into which on the one hand the fuel/oxidizing agent mixture and on the other hand the water vapor/carrier gas mixture, through an additional supply line, are supplied. The mixture is supplied to the reaction chamber with the catalytically active surface in that it is converted to a hydrogen-rich mixture. The hot reformate flows to the right, the heat being given off at the first heat exchanger, which is arranged in the reformer part in a spiral shape. Then the reformate is conducted into the combustion part, flows through the third heat exchanger, and then exits the system.

On the right-hand side, the residual anode gas enters the second mixing chamber with the required quantity of oxidizing agent for burning the residual node gas. The gas mixture is conducted to the burner chamber. Here, as well, a catalyst leads to the conversion of the residual anode gas by means of total oxidation. The hot gas thus purified is cooled via the second and third heat exchangers and removed.

The added water/carrier gas mixture is first conducted via the first and second heat exchangers, where it absorbs the heat given off by the reformate and burner exhaust gas and can be conducted into the mixing chamber 1 as water vapor/carrier gas mixture.

1.-8. (canceled)

9. Apparatus for producing hydrogen-rich product gas in an autothermic reformer comprising:
a reformer part having a reaction chamber that has an inlet for a fuel/oxidizing agent mixture, an inlet for a water/carrier gas mixture, a catalytic surface, and an outlet for a hydrogen-rich product gas, and having a first heat exchanger that surrounds both said outlet and said reaction chamber itself;
a combustion part having an inlet for a residual anode gas from a fuel cell, an inlet for an oxidizing agent, a burner chamber having a catalytic surface, and a second heat exchanger that surrounds said burner chamber;
said reformer part and said combustion part being arranged directly adjacent to one another and being connected by lines that are suitable for supplying a water vapor/carrier gas mixture and for conducting said hydrogen-rich product gas.

10. Apparatus in accordance with claim 9, in which a line for a water vapor/carrier gas mixture connects said first heat exchanger to said second heat exchanger.

11. Apparatus in accordance with claims 9 or 10, having spiral heat exchangers as first and second heat exchangers.

12. Apparatus in accordance with claim 11, comprising a third heat exchanger that also surrounds said burner chamber.

13. Apparatus in accordance with claim 12, in which said third heat exchanger is also embodied as a spiral heat exchanger.

14. Method for producing a hydrogen-rich product gas in an autothermic reformer comprising the steps:
a water vapor/carrier gas mixture is supplied to a mixing chamber via a feed line, and a fuel/oxidizing agent mixture is supplied via a nozzle;
said fuel/water vapor/oxidizing agent/carrier gas mixture is converted catalytically in a reaction chamber in exothermic and endothermic reactions into a hydrogen-rich product gas;
the heat thereby released is removed via a first heat exchanger that surrounds said reaction chamber;
a residual anode gas from a fuel cell is converted catalytically in a burnerchamber in an exothermic reaction into exhaust gas that is low in harmful substances;
the heat thereby released is removed via a second heat exchanger that surround said burner chamber;
the heat required for evaporating water to create water vapor in said water vapor/carrier gas mixture is provided by cooling said reformer and said hydrogen-rich product gas and by cooling said exhaust gas that is from said burner chamber and that is low in harmful substances, said water vapor/carrier gas mixture passing through both heat exchangers one after the other.
